(19) United States
(12) Patent Application Publication
(10) Pub. No.: US 2013/0149211 A1
(43) Pub. Date: Jun. 13, 2013

(54) GRAPHENE OXIDE AND GRAPHITE OXIDE CATALYSTS AND SYSTEMS

(71) Applicants: Christopher W. Bielawski, Austin, TX (US); Daniel R. Dreyer, Austin, TX (US)

(72) Inventors: Christopher W. Bielawski, Austin, TX (US); Daniel R. Dreyer, Austin, TX (US)

(73) Assignee: GRAPHEA, INC., Austin, TX (US)

(21) Appl. No.: 13/700,432

(22) PCT Filed: May 27, 2011
(86) PCT No.: PCT/US11/38327

§ 371 Date: Jan. 23, 2013

Related U.S. Application Data
(60) Provisional application No. 61/349,378, filed on May 28, 2010.
(60) Provisional application No. 61/440,574, filed on Feb. 8, 2011.

(51) Int. Cl. B01J 31/04; B01J 19/00

(52) U.S. Cl. CPC B01J 31/04; B01J 19/00
USPC 422/198; 549/543; 422/211; 422/223

(57) ABSTRACT

A carbocatalyst for use in oxidation and polymerization reactions includes particles having a carbon and oxygen-containing material, such as catalytically-active graphene oxide and/or catalytically-active graphite oxide. In some cases, the particles are disposed on a solid support formed of a carbon-containing material, such as graphene or graphite, or a non-carbon containing material, such as a metallic or insulating material.

### CROSS-REFERENCE

This application claims priority to U.S. Provisional Patent Application Ser. No. 61/349,378, filed May 28, 2010, and U.S. Provisional Patent Application Ser. No. 61/440,574, filed Feb. 8, 2011, which are entirely incorporated herein by reference.

### STATEMENT AS TO FEDERALLY SPONSORED RESEARCH

At least a portion of this invention was developed with the support of the United States government under Grant DMR-0907324 from The National Science Foundation.

### BACKGROUND OF THE INVENTION

A catalyst is a substance that facilitates a chemical reaction but is typically not consumed in the reaction. Kinetically, a catalyst facilitates a chemical reaction by lowering the barrier to activation.

A heterogeneous catalyst is typically a solid that acts on a substrate in a liquid or gaseous reaction mixture. Diverse mechanisms for reactions on heterogeneous catalyst surfaces are known, depending on how liquid-to-solid or gas-to-solid adsorption takes place (e.g., Langmuir-Hinshelwood, Eley-Rideal and Mars-van Krevelen).

Catalysts for use in various types of reactions typically include one or more transition metals as the catalytically active material.

### SUMMARY OF THE INVENTION

In an aspect of the invention, carbocatalysts are provided. In an embodiment, a non-transition metal catalyst comprises catalytically-active graphene oxide or catalytically-active graphite oxide, the catalyst having a transition metal content less than about 1 part per million.

In another embodiment, a catalyst comprises catalytically-active graphene oxide or catalytically-active graphite oxide, the catalytically-active graphene oxide or catalytically-active graphite oxide having at least one surface moiety selected from the group consisting of an alkyl group, aryl group, alkenyl group, alkynyl group, hydroxyl group, epoxide group, peroxide group, peroxyacid group, aldehyde group, ketone group, ether group, carboxylic acid or carboxylate group, peroxide or hydroperoxide group, lactone group, thiolactone, lactam, thiolactam, quinone group, anhydride group, ester group, carbonate group, acetal group, hemiacetal group, ketal group, hemiketal group, aminal, hemiaminal, carbamate, isocyanate, isothiocyanate, cyanamide, hydrazine, hydrazide, carbodiimide, oxime, oxime ether, N-heterocycle, N-oxide, hydroxylamine, hydrazine, semicarbazone, thiosemicarbazone, urea, isourea, thiourea, isothiourea, enamine, enol ether, aliphatic, aromatic, phenolic, thiol, thioether, thioester, dithioester, disulfide, sulfoxide, sulfone, sultone, sulfinic acid, sulfenic acid, sulfenic ester, sulfonic acid, sulfite, sulfate, sulfonate, sulfonamide, sulfonyl halide, thiocyanate, thiol, thial, S-heterocycle, silyl, trimethylsilyl, phosphine, phosphate, phosphoric acid amide, thiophosphate, thiophosphoric acid amide, phosphonate, phosphinite, phosphite, phosphate ester, phosphonate diester, phosphine oxide, amine, imine, amide, aliphatic amide, aromatic amide, halogen, chloro, iodo, fluoro, bromo, acyl halide, acyl fluoride, acyl chloride, acyl bromide, acyl iodide, acyl cyanide, acyl azide, ketene, alpha-beta unsaturated ester, alpha-beta unsaturated ketone, alpha-beta unsaturated aldehyde, anhydride, azide, diazo, diazonium, nitrate, nitrate ester, nitroso, nitrile, nitrite, orthoester group, orthocarbonate ester group, O-heterocycle, borane, boronic acid and boronic ester. The at least one surface moiety has a surface coverage less than or equal to about 1.0 monolayer (ML).

In another embodiment, a catalyst comprises catalytically-active graphene oxide or graphite oxide, the catalyst having a carbon-containing surface with islands of an oxygen-containing material on the carbon-containing surface, the islands having a surface coverage less than or equal to about 1.0 monolayers (ML).

In another embodiment, a carbon-containing material comprises an extended carbon atom layer; and a layer of a catalytically-active carbon-containing material chemisorbed or physisorbed on a surface of the extended carbon atom layer.

In another embodiment, a catalyst comprises a carbon-containing material having one or more Fourier Transform Infrared (FT-IR) features at about 3150 cm⁻¹, 1685 cm⁻¹, 1280 cm⁻¹ and 1140 cm⁻¹, the carbon-containing material having a surface with at least one surface moiety selected from the group consisting of an alkyl group, aryl group, alkenyl group, alkynyl group, hydroxyl group, epoxide group, peroxide group, peroxyacid group, aldehyde group, ketone group, ether group, carboxylic acid or carboxylate group, peroxide or hydroperoxide group, lactone group, thiolactone, lactam, thiolactam, quinone group, anhydride group, ester group, carbonate group, acetal group, hemiacetal group, ketal group, hemiketal group, aminal, hemiaminal, carbamate, isocyanate, isothiocyanate, cyanamide, hydrazine, hydrazide, carbodiimide, oxime, oxime ether, N-heterocycle, N-oxide, hydroxylamine, hydrazine, semicarbazone, thiosemicarbazone, urea, isourea, thiourea, isothiourea, enamine, enol ether, aliphatic, aromatic, phenolic, thiol, thioether, thioester, dithioester, disulfide, sulfoxide, sulfone, sultone, sulfinic acid, sulfenic acid, sulfenic ester, sulfonic acid, sulfite, sulfate, sulfonate, sulfonamide, sulfonyl halide, thiocyanate, thiol, thial, S-heterocycle, silyl, trimethylsilyl, phosphine, phosphate, phosphoric acid amide, thiophosphate, thiophosphoric acid amide, phosphonate, phosphinite, phosphite, phosphate ester, phosphonate diester, phosphine oxide, amine, imine, amide, aliphatic amide, aromatic amide, halogen, chloro, iodo, fluoro, bromo, acyl halide, acyl fluoride, acyl chloride, acyl bromide, acyl iodide, acyl cyanide, acyl azide, ketene, alpha-beta unsaturated ester, alpha-beta unsaturated ketone, alpha-beta unsaturated aldehyde, anhydride, azide, diazo, diazonium, nitrate, nitrate ester, nitroso, nitrile, nitrite, orthoester group, orthocarbonate ester group, O-heterocycle, borane, boronic acid, and boronic ester.

In another embodiment, a carbocatalyst comprises a carbon-containing material and a layer of an organic material on a surface of the carbon-containing material, the layer of the organic material having a surface area of at least about 0.01 wt %.

In another embodiment, a carbocatalyst comprises a solid support and carbon-containing particles on the solid support, the carbon-containing particles formed of a material selected from the group consisting of graphene, graphite, graphene oxide, graphite oxide, and oxidized carbon.

In another aspect, a spent catalyst comprises a carbon-containing material having a Fourier Transform Infrared (FT-IR) spectrum with at least one FT-IR feature at about 3150 cm⁻¹, 1685 cm⁻¹, 1280 cm⁻¹ and 1140 cm⁻¹ that is attenuated with respect to a fresh catalyst.

In an embodiment, a spent carbocatalyst comprises a solid support and carbon-containing particles on the solid support, each of the particles having a surface area to circumference ratio between about 1 nanometers and 10,000 micrometers.

In another aspect, a heterogeneous catalyst comprises a solid support and graphene oxide or graphite oxide particles on the solid support. The graphene oxide or graphite oxide particles comprise catalytically-active graphene oxide or graphite oxide.

In an embodiment, a heterogeneous catalyst is provided having graphene oxide or graphite oxide on a solid support, the catalyst having a graphene oxide or graphite oxide content of at least about 0.0001 wt %. The graphene oxide or graphite oxide are catalytically active.

In another aspect, a graphene oxide or graphite oxide-containing system comprises a source of a carbon-containing reactant and a reactor having a graphene oxide or graphite oxide-containing catalyst downstream from the source of the carbon-containing reactant, the reactor in fluid communication with the source of the carbon-containing reactant.

In an embodiment, a fluidized bed reactor comprises a housing having a reactor inlet and a reactor outlet downstream from the reactor inlet, and catalyst particles in the housing, the catalyst particles comprising graphene oxide or graphite oxide.

In another embodiment, a shell-and-tube reactor comprises a housing having a reactor inlet and a reactor outlet downstream from the reactor inlet, and one or more tubes in fluid communication with the reactor inlet and the reactor outlet, the one or more tubes having one or more inner surfaces, the one or more inner surfaces having graphene oxide or graphite oxide.

In another aspect, methods for forming carbocatalysts are provided. In an embodiment, a method for forming a graphene oxide or graphite oxide catalyst from a nascent catalyst comprises the steps of: (a) providing a nascent catalyst comprising graphene or graphite to a reaction chamber; (b) contacting the nascent catalyst with one or more acids; and (c) contacting the nascent catalyst with a chemical oxidant.

In another embodiment, a method for forming a graphene oxide or graphite oxide catalyst from a nascent catalyst comprises providing a nascent catalyst to a reaction chamber, the nascent catalyst comprising graphene or graphite on a solid support; heating the nascent catalyst in the reaction chamber to an elevated temperature; and contacting the nascent catalyst with a chemical oxidant.

In another embodiment, a method for forming a graphene oxide or graphite oxide catalyst from a nascent catalyst comprises the steps of: (a) providing a nascent catalyst comprising graphite to a reaction chamber; (b) contacting the nascent catalyst with one or more acids; and (c) contacting the nascent catalyst with sodium chlorate, potassium chlorate or potassium perchlorate.

In another embodiment, a method for forming a carbocatalyst comprises providing a carbon-containing material in a reaction chamber; and contacting the carbon-containing material in the reaction chamber with an oxidizing chemical until the carbon-to-oxygen ratio of the carbon-containing material is less than or equal to about 1,000,000 to 1.

In another embodiment, a method for forming oxidized graphite or oxidized graphene comprises providing a graphite or graphene substrate in a reaction chamber; and contacting the graphite or graphene substrate with an oxidizing chemical until an infrared spectroscopy spectrum of the graphite or graphene substrate exhibits one or more features at 3150 cm⁻¹, 1685 cm⁻¹, 1280 cm⁻¹ and 1140 cm⁻¹.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates a potential structure of graphene oxide;

FIG. 2 illustrates a carbocatalyst, in accordance with an embodiment of the invention;

FIG. 3A is a schematic side view of a heterogeneous catalyst, in accordance with an embodiment of the invention. FIG. 3B is a schematic top view of the heterogeneous catalyst of FIG. 3A;

FIG. 4 schematically illustrates a system having a reactor comprising a carbocatalyst, in accordance with an embodiment of the invention; and

FIG. 5 is a Fourier-Transform Infrared (FT-IR) spectrum of a carbocatalyst, in accordance with an embodiment of the invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “catalyst,” as used herein, refers to substance or species that facilitates one or more chemical reactions. A catalyst includes one or more reactive active sites for facilitating a chemical reaction, such as, for example, surface moieties (e.g., OH groups, ketones, aldehydes, carboxylic acids). The term catalyst includes a graphene oxide, graphite oxide, or other carbon and oxygen-containing material that facilitates a chemical reaction, such as an oxidation reaction or polymerization reaction. In some situations, the catalyst is incorporated into the reaction product and/or byproduct. As one example, a graphene or graphite oxide catalyst for facilitating a polymerization reaction is at least partially incorporated into a polymer matrix of the polymer formed in the reaction.

The term “carbocatalyst,” as used herein, refers to a catalyst that includes graphite, graphite oxide, graphene, graphene oxide, or closely related carbon materials for the transformation or synthesis of organic or inorganic substrates, or the polymerization of monomeric subunits (also “monomers” herein).

The term “spent catalyst,” as used herein, refers to a catalyst that has been exposed to a reactant to generate a product. In some situations, a spent catalyst is incapable of facilitating a chemical reaction. A spent catalyst has reduced activity with respect to a freshly generated catalyst (also “fresh catalyst” herein). The spent catalyst is partially or wholly deactivated. In some cases, such reduced activity is ascribed to a decrease in the number of reactive active sites.

The term “heterogeneous catalyst,” as used herein, refers to a solid-phase species configured to facilitate a chemical transformation. In heterogeneous catalysis, the phase of the heterogeneous catalyst generally differs from the phase of the reactants(s). A heterogeneous catalyst includes a catalytically active material on a solid support. In some cases the support is catalytically active or inactive. In some situations, the catalytically active material and the solid support is collectively referred to as a “heterogeneous catalyst” (or “catalyst”).

The term “solid support,” as used herein, refers to a support structure for holding or supporting a catalytically active material, such as a catalyst (e.g., carbocatalyst). In some cases, a solid support does not facilitate a chemical reaction. However, in other cases the solid support takes part in a chemical reaction.

The term “nascent catalyst,” as used herein, refers to a substance or material that is used to form a catalyst. A nascent catalyst is characterized as a species that has the potential for acting as a catalyst, such as, upon additional processing or chemical and/or physical modification or transformation.

The term “surface,” as used herein, refers to the boundary between a liquid and a solid, a gas and a solid, a solid and another solid, or a gas and a liquid. A species on a surface has decreased degrees of freedom with respect to the species in the gas or liquid phase.

The term “monolayer,” as used herein, refers to a single layer of atoms or molecules. A monolayer includes a monatomic monolayer (ML) having a thickness of one atomic layer. The term “complete monolayer” refers to embodiments in which the maximum coverage of a particular species is present on a surface. The term “partial monolayer” refers to embodiments in which less than the maximum coverage of a particular species is present on a surface. The term “monolayer” includes both complete and partial monolayers. In the case of a complete monolayer, all individual members of species adsorbed on the surface are in direct physical contact with the surface of the underlying substrate, thin film, or film. The maximum coverage of a species on a surface is determined by the attractive and repulsive interactions between adsorbed species on the surface. In some situations, a layer of a species at a coverage of one monolayer will not permit additional adsorption of the species in the layer. In some situations, a layer of a species at a coverage of one monolayer will permit adsorption of additional species on the layer, leading to “multilayer” coverage of the species. In other situations, however, a layer of a particular species at a coverage of one monolayer will permit the adsorption of another species in the layer.

The term “fluid,” as used herein, refers to any substance that continually deforms (flows) under an applied shear stress. A fluid includes one or more of a liquid, gas, plasma and polymeric material.

The term “excited species,” as used herein, refers to radicals, ions and other excited (or activated) species generated via application (or coupling) of energy to a reactant gas or vapor. Energy is applied via a variety of methods, such as, e.g., ultraviolet radiation, microwave radiation, inductive coupling and capacitive coupling. In some cases, energy is applied with the aid of a plasma generator, such as a direct plasma generator (i.e., in situ plasma generation) or a remote plasma generator (i.e., ex situ plasma generation). In such a case, the excited species is referred to as “plasma excited species.” In the absence of coupling energy, plasma generation is terminated. For remote plasma generation, plasma-excited species of a particular vapor phase chemical (e.g., oxygen-containing plasma excited species) are formed in a plasma generator in fluid communication with (or fluidically coupled to) a reaction chamber having a substrate to be processed. In some situations, energy is applied by exposure of a species of gas or liquid to hot (or heated) surfaces or wires, where the interaction of the gas or liquid with the heated surfaces or wires generates excited species of the gas or liquid.

The term “graphene oxide,” as used herein, refers to catalytically-active graphene oxide.

The term “graphite oxide,” as used herein, refers to catalytically-active graphite oxide.

Recognized herein are various limitations associated with current commercially-available methods catalyzing chemical reactions. For instance, while transition metal-based catalysts may provide reactions rates that are commercially feasible, the use of metal catalysts has various drawbacks, such as metal contamination of the resulting products. This is particularly problematic in industries where the product is intended for health or biological use, or other uses sensitive to the presence of metals. Another drawback of metal catalysts is that metal catalysts are typically not selective in oxidation reactions and may not tolerate the presence of functional groups in the reactants.

As another example to illustrate the drawbacks of metal-based catalysts recognized herein, transition metal-based catalysts may be expensive to manufacture and processes employing such catalysts may have considerable startup and maintenance costs.

In view of such limitations associated with current catalysts and systems, recognized herein is the need for catalysts, such as oxidation, hydration, condensation, and dehydrogenation catalysts and polymerization catalysts, that minimize, if not eliminate, the problems associated with metal contamination of the reaction end product, and also provide for reduced cost.

In some embodiments of the invention, carbocatalysts are described that are configured for use with oxidation and/or polymerization reactions. Such carbocatalysts enable reaction rates up to and even exceeding that of transition metal-based catalysts, but reduce, if not eliminate, the contamination issues associated with the use of transition metal-based catalysts.

In some embodiments, catalysts are provided having catalytically-active graphene oxide and/or catalytically-active graphite oxide on a solid support. In other embodiments, catalysts are provided having a catalytically-active carbon and oxygen-containing material on a solid support.

In some embodiments, heterogeneous catalysts are provided having catalytically-active graphene oxide and/or catalytically-active graphite oxide on a solid support. In other embodiments, heterogeneous catalysts are provided having a catalytically-active carbon and oxygen-containing material on a solid support.

In some embodiments, carbocatalysts provided herein, including heterogeneous catalysts, are used in oxidation, hydration, dehydrogenation, condensation, or polymerization reactions, or auto-tandem oxidation-hydration-condensation reactions. For example, catalysts provided herein are used for the catalytic oxidation of primary or secondary alcohols to their respective ketones or aldehydes. As another example, catalysts provided herein are used for alkene oxidation, in which the catalyst functions as a catalytic oxidant for the transformation of an alkene, such as an aromatic or aliphatic alkene, to a dione. As another example, catalysts provided herein are used in alkyne hydration.

In some embodiments, catalysts provided herein are used in alkane, alkene or alkyne oxidation to one or more of alcohols, aldehydes, ketones and carboxylic acids. In other embodiments, catalysts provided herein are used to catalyze the formation of a chalcone from a ketone (e.g., methyl ketone) and an aldehyde. In other embodiments, catalysts provided herein are used to catalyze an auto-tandem chemical reaction to form a chalcone. In other embodiments, catalysts provided herein are used in polymerization reactionsi.e., polymerizing one or more monomeric subunits (also “monomers” herein) to form a polymeric material. Examples of polymerization reactions are oxidation reactions, dehydration reactions, and cationic polymerization reactions.

Graphene or graphite oxide catalysts

In an aspect of the invention, carbon-containing catalysts configured to facilitate a chemical reaction, such as an oxidation reaction or a polymerization reaction, are described. In some embodiments, carbon-containing catalysts are catalytically-active graphene oxide, graphite oxide or other carbon and oxygen-containing catalysts, including heterogeneous catalysts. In some situations, a carbon-containing catalyst is a graphene oxide catalyst or a graphite oxide catalyst.

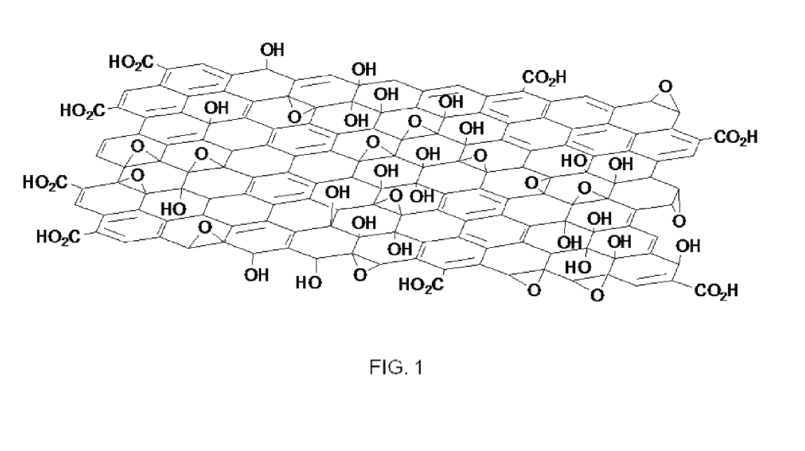

FIG. 1 schematically illustrates a carbon and oxygen-containing material, which in some cases is representative of a potential structure of graphene oxide having a plurality of oxygen-containing functional groups, such as, e.g., hydroxyl (OH), aldehyde and carboxylic acid. In some situations, at least some of the oxygen-containing functional groups are used to oxidize organic species, such as alkenes and alkynes, or used to polymerize monomeric subunits (also “monomers” herein). Various embodiments of the invention describe carbocatalysts having graphene oxide at various compositions, concentrations and islands shapes, coverage and adsorption locations.

Carbon-containing catalysts provided herein include unsupported catalytically-active graphene or catalytically-active graphite oxide, as well as graphene or graphite oxide on a solid support, such as a carbon-containing solid support or metal-containing solid support (e.g., TiO₂, Al₂O₃). In some situations, catalysts provided herein have a substantially low transition metal content. As an example, a non-transition metal catalyst includes graphene oxide or graphite oxide and have a transition metal content less than or equal to about 1 part per million (ppm). In some cases, the transition metal content of the non-transition metal catalyst is less than or equal to about 0.5 ppm, or less than or equal to about 0.1 ppm, or less than or equal to about 0.06 ppm, or less than or equal to about 0.01 ppm, or less than or equal to about 0.001 ppm, or less than or equal to about 0.0001 ppm, or less than or equal to about 0.00001 ppm. In some situations, the transition metal content of the non-transition metal catalyst is determined by atomic absorption spectroscopy (AAS) or other elemental analysis techniques, such as x-ray photoelectron spectroscopy (XPS) or mass spectrometry (e.g., inductively coupled plasma mass spectrometry, or “ICP-MS”). In some embodiments, the non-transition metal catalyst has a low concentration of transition metals selected from the group consisting of W, Fe, Ta, Ni, Au, Ag, Rh, Ru, Pd, Pt, Ir, Co, Mn, Os, Zr, Zn, Mo, Re, Cu, Cr, V, Ti and Nb. In some embodiments, a non-transition metal catalyst has a metal content (mole %) that is less than about 0.0001%, or less than about 0.000001%, or less than about 0.0000001%.

In some embodiments, a non-transition metal catalyst having catalytically-active graphene oxide or graphite oxide has a surface that is configured to come in contact with a reactant, such as a hydrocarbon for oxidation or monomeric subunits for polymerization. In some cases, the catalyst has a surface that is terminated by one or more of hydrogen peroxide, hydroxyl groups (OH), aldehyde groups, or carboxylic acid group. In an embodiment, the catalyst has a surface that includes one or more species (or “surface moieties”) selected from the group consisting of an alkyl group, aryl group, alkenyl group, alkynyl group, hydroxyl group, epoxide group, peroxide group, peroxyacid group, aldehyde group, ketone group, ether group, carboxylic acid or carboxylate group, peroxide or hydroperoxide group, lactone group, thiolactone, lactam, thiolactam, quinone group, anhydride group, ester group, carbonate group, acetal group, hemiacetal group, ketal group, hemiketal group, aminal, hemiaminal, carbamate, isocyanate, isothiocyanate, cyanamide, hydrazine, hydrazide, carbodiimide, oxime, oxime ether, N-heterocycle, N-oxide, hydroxylamine, hydrazine, semicarbazone, thiosemicarbazone, urea, isourea, thiourea, isothiourea, enamine, enol ether, aliphatic, aromatic, phenolic, thiol, thioether, thioester, dithioester, disulfide, sulfoxide, sulfone, sultone, sulfuric acid, sulfenic acid, sulfenic ester, sulfonic acid, sulfite, sulfate, sulfonate, sulfonamide, sulfonyl halide, thiocyanate, thiol, thial, S-heterocycle, silyl, trimethylsilyl, phosphine, phosphate, phosphoric acid amide, thiophosphate, thiophosphoric acid amide, phosphonate, phosphinite, phosphite, phosphate ester, phosphonate diester, phosphine oxide, amine, imine, amide, aliphatic amide, aromatic amide, halogen, chloro, iodo, fluoro, bromo, acyl halide, acyl fluoride, acyl chloride, acyl bromide, acyl iodide, acyl cyanide, acyl azide, ketene, alpha-beta unsaturated ester, alpha-beta unsaturated ketone, alpha-beta unsaturated aldehyde, anhydride, azide, diazo, diazonium, nitrate, nitrate ester, nitroso, nitrile, nitrite, orthoester group, orthocarbonate ester group, O-heterocycle, borane, boronic acid and boronic ester. In an example, such surface moieties are disposed on the surface at various reactive active sites of the catalyst.

In some embodiments, a catalytically-active graphene oxide or graphite oxide catalyst (or other carbon and oxygen-containing catalyst) has a carbon content (mole %) of at least about 25%, or 30%, or 35%, or 40%, or 45%, or 50%, or 55%, or 60%, or 65%, or 70%, or 75%, or 80%, or 85%, or 90%, or 95%, or 99%, or 99.99%. In some situations, The balance of the catalyst is oxygen. In other situations, the balance of the catalyst includes one or more elements selected from the group consisting of oxygen, boron, nitrogen, sulfur, phosphorous, fluorine, chlorine, bromine and iodine. In some embodiments, a graphene oxide or graphite oxide has an oxygen content of at least about 0.01%, or 1%, or 5%, or 15%, or 20%, or 25%, or 30%, or 35%, or 40%, or 45%, or 50%. For example, a graphene or graphite oxide catalyst has a carbon content of at least about 25% and an oxygen content of at least about 0.01%. The oxygen content is measured with the aid of various surface, titrimetric, or bulk analytical spectroscopic techniques. As one example, the oxygen content is measured by x-ray photoelectron spectroscopy (XPS).

In some embodiments, a carbocatalyst has a bulk carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1. In some cases, a carbocatalyst has a surface carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1.

In some embodiments, a catalytically-active graphene oxide or graphite oxide-containing catalyst has graphene oxide or graphite oxide with a bulk carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1. In some cases, a graphene oxide or graphite oxide-containing catalyst includes graphene oxide or graphite oxide with a surface carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1.

In some embodiments, carbocatalysts provided herein have various bulk properties. In one embodiment, a carbocatalyst has a bulk density between about 0.01 g/cm³ and 10 g/cm³, or 0.1 g/cm³ and 5.0 g/cm³, or 0.2 g/cm³ and 2.2 g/cm³, as measured by pycnometry. In another embodiment, a carbocatalyst has a decomposition temperature (onset) range between about −50° C. and 600° C., as measured by thermogravimetric analysis. In another embodiment, a carbocatalyst has a surface area between about 0.001 m²/g and 5000 m²/g, or 0.01 m²/g and 3000 m²/g, as measured via the BET method.

In some embodiments, carbocatalysts provided herein have various bulk conductivity properties. In one embodiment, a graphite oxide-containing carbocatalyst has a bulk conductivity up to about 10⁻⁶ S/m, 10⁻⁵ S/m, or 10⁻⁴ S/m, or 10⁻³ S/m, or 10⁻² S/m, or 10⁻¹ S/m, or 1 S/m, or 5 S/m, or 10 S/m, or 50 S/m, or 100 S/m, or 500 S/m, or 1000 S/m, or 5000 S/m, or 10,000 S/m. In another embodiment, graphite oxide-containing carbocatalyst has a bulk thermal conductivity between about 0.001 W/m·K and 1 W/m·K, or between about 0.01 W/m·K and 0.5 W/m·K, or between about 0.05 W/m·K and 0.1 W/m·K.

In some embodiments, a catalyst is provided comprising catalytically-active graphene oxide or graphite oxide, the graphene oxide or graphite oxide having at least one surface moiety described above, such as an alkyl group, aryl group, alkenyl group, alkynyl group, hydroxyl group, epoxide group, peroxide group, peroxyacid group, aldehyde group, ketone group, ether group, carboxylic acid or carboxylate group. In some cases, the at least one surface moiety has a surface coverage that is less than or equal to about 1.0 monolayer (ML). In some cases, the surface moiety has a surface coverage that is less than or equal to about 0.99 ML, or 0.95 ML, or 0.9 ML, or 0.85 ML, or 0.8 ML, or 0.75 ML, or 0.7 ML, or 0.65 ML, or 0.6 ML, or 0.55 ML, or 0.5 ML, or 0.45 ML, or 0.4 ML, or 0.35 ML, or 0.3 ML, or 0.25 ML, or 0.2 ML, or 0.15 ML, or 0.1 ML, or 0.05 ML, or 0.01 ML, or 0.005 ML, or 0.001 ML. In other cases, the at least one surface moiety has a coverage that is greater than equal to about 1 ML, or 2 ML, or 3 ML, or 4 ML, or 5 ML, or 6 ML, or 7 ML, or 8 ML, or 9 ML, or 10 ML, or 20 ML, or 30 ML, or 40 ML, or 50 ML, or 60 ML, or 70 ML, or 80 ML, or 90 ML, or 100 ML, or 500 ML, or 1000 ML, or 10,000 ML.

In some situations, a carbocatalyst includes a carbon-containing species, such as catalytically-active graphene oxide or graphite oxide, having a carbon-containing surface with islands of an oxygen-containing material on the carbon-containing surface. In one embodiment, the islands have a surface coverage that is less than or equal to about 1.0 monolayer (ML). In some cases, the islands have a surface coverage that is less than or equal to about 0.99 ML, or 0.95 ML, or 0.9 ML, or 0.85 ML, or 0.8 ML, or 0.75 ML, or 0.7 ML, or 0.65 ML, or 0.6 ML, or 0.55 ML, or 0.5 ML, or 0.45 ML, or 0.4 ML, or 0.35 ML, or 0.3 ML, or 0.25 ML, or 0.2 ML, or 0.15 ML, or 0.1 ML, or 0.05 ML, or 0.01 ML, or 0.005 ML, or 0.001 ML. The island coverage in such cases is determined with the aid of various surface analytical techniques, such as, for example, XPS, scanning tunneling microscopy (STM) and/or atomic force microscopy (AFM).

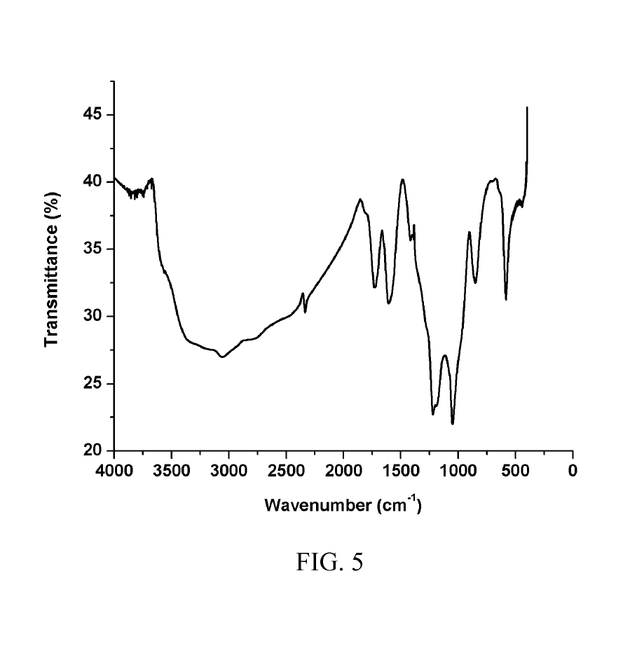

In some embodiments, a carbocatalyst having a carbon-containing catalytically active material, such as catalytically-active graphene oxide or graphite oxide, has one or more Fourier Transform Infrared (FT-IR) features (or “wavenumbers”) at about 3150 cm⁻¹, 1685 cm⁻¹, 1280 cm⁻¹ and 1140 cm⁻¹ (see FIG. 5). In some cases, an FT-IR spectrum of the carbocatalyst will exhibit one, two, three or all FT-IR features selected from 3150 cm⁻¹, 1685 cm⁻¹, 1280 cm⁻¹ and 1140 cm⁻¹. In some situations, the distribution of FT-IR features depends on functional groups present on a surface of the carbocatalyst. In some cases, such FT-IR features are limited to the surface of the carbocatalyst.

In some embodiments, a carbocatalyst includes a carbon-containing material, such as graphene oxide or graphite oxide, and a layer of an organic material on a surface of the carbon-containing material. In some cases, the layer of the organic material has a surface area of at least about 0.005%, or 0.01%, or 0.05%, or 0.1%, or 0.5%, or 1%, or 5%, or 10%, or 15%, or 20%, or 25%, or 30%, or 35%, or 40%, or 45%, or 50%, or 55%, or 60%, or 65%, or 70%, or 75%, or 80%, or 85%, or 90%, or 95%, or 99%, or 99.9%. The surface area may be measured by various surface analytical techniques. Examples of surface analytical techniques are STM, AFM and temperature programmed desorption (TPD) spectroscopy. In some situations, the layer of the organic material includes one or more surface moieties described above, such as hydroxyl group, epoxide group, peroxide group, peroxyacid group, aldehyde group, ketone group, ether group, carboxylic acid, alkyl group, aryl group, alkenyl group, alkynyl group, or carboxylate group.

In some situations, a carbocatalyst includes an extended carbon atom layer and a layer having one or more of oxygen, boron, nitrogen, sulfur, phosphorous, fluorine, chlorine, bromine and/or iodine-containing species (e.g., an OH layer, SO₃ layer) chemisorbed or physisorbed on a surface of the extended carbon atom layer. In one example, the extended carbon atom layer is a freestanding monolayer. In some cases, the carbocatalyst further includes another layer having one or more of oxygen, boron, nitrogen, sulfur, phosphorous, fluorine, chlorine, bromine and/or iodine-containing species chemisorbed or physisorbed on another surface of the extended carbon atom layer. In an example, the carbocatalyst includes a carbon support structure with layers of an oxygen-containing material formed on opposing surfaces of the carbon support. The layers of the oxygen-containing material include carbon and oxygen having a grapheme oxide or graphite oxide-type structure.

Alternatively, a carbocatalyst includes an extended carbon atom layer and a layer of a catalytically-active carbon-containing material. In some instances, such a layer includes one or more atoms selected from the group consisting of oxygen, boron, nitrogen, sulfur, phosphorous, fluorine, chlorine, bromine and iodine. In some embodiments, the carbocatalyst includes another layer of a catalytically-active carbon-containing material. In some instances, such a layer includes one or more atoms selected from the group consisting of oxygen, boron, nitrogen, sulfur, phosphorous, fluorine, chlorine, bromine and iodine. In an example, the layer of catalytically-active carbon-containing material includes oxygen (e.g., OH groups).

In some cases, the islands of an oxygen-containing species are disposed at or near surface defect locations, such as steps (e.g., monatomic steps), screw dislocations, hairpin turn dislocations and/or edge dislocations. Such islands are two or three-dimensional islands.

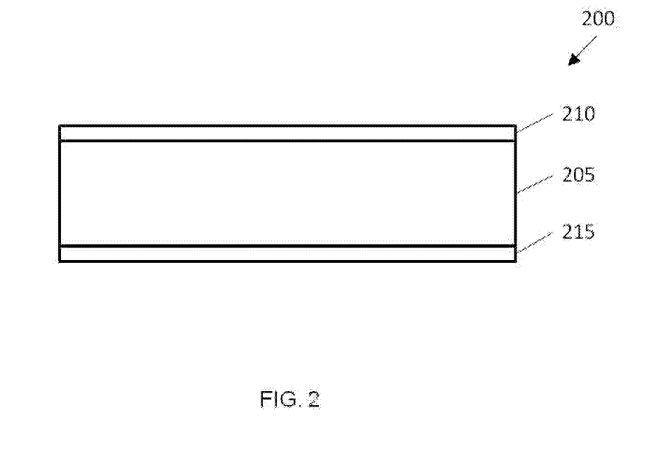

FIG. 2 shows a carbocatalyst 200, in accordance with an embodiment of the invention. The carbocatalyst 200 includes a support structure 205 with a first layer 210 of a carbon and oxygen-containing material on the support structure 205. In some situations, the first layer 210 is a freestanding layer. As an example, the first layer 210 includes catalytically-active graphite oxide or catalytically-active graphene oxide. In some cases, the carbocatalyst 200 includes one or more other layers of a carbon and oxygen-containing material on the support structure 205. For instance, the carbocatalyst 200 includes a second layer 215 of a carbon and oxygen-containing material on the support structure 205. In some situations, the second layer 215 is a freestanding layer. As an example, the second layer 215 includes graphite oxide or graphene oxide.

In some cases, the support structure 205 is formed of carbon or carbon-containing material, such as elemental carbon, graphene, graphite, graphene oxide and/or graphite oxide. In one example, the support structure 205 includes graphene or graphite. In other cases, the support structure 205 is formed of a non-carbon containing material, such as a metallic or insulating material. In one example, the support structure 205 is formed of AlOₓ, TiOₓ, SiOₓ, ZrOₓ, or combinations thereof, wherein ‘x’ is a number greater than zero.

In some embodiments, a carbocatalyst includes a solid support and carbon-containing particles on the solid support. In one embodiment, the carbon-containing particles are formed of a material selected from the group consisting of graphene, graphite, graphene oxide, graphite oxide, and oxidized carbon. In some situations, the carbocatalyst is formed of graphene or graphite oxide. In another embodiment, the solid support is formed of a catalytically-active carbon-containing material, such as graphite or graphene, or a non-carbon containing material, such as a metallic material selected from the group consisting of AlOₓ, TiO_{X}, SiOₓ, ZrOₓ and combinations thereof, wherein ‘x’ is a number greater than zero.

The catalytically-active carbon-containing particles may be adsorbed or absorbed on the solid support. In one example, the carbon-containing particles are covalently bound (or “chemisorbed”) to the solid support. In another example, the carbon-containing particles are physisorbed on the solid support.

In some embodiment, the carbon-containing particles have contact angles less than or equal to about 180°, or between 0° and 180°. In one example, the carbon-containing particles have contact angles of about 45° or 90°. The contact angles may vary based on the material of the solid support. In some cases, particles on a carbon-containing solid support have lower contact angles than particles on a non-carbon containing solid support.

In some embodiments, the particles have particle sizes (e.g., diameters) less than or equal to about 1000 micrometers (“82 m”), or 500 μm, or 100 μm, or 50 μm, or 10 μm, or 5 μm, or 1 μm, or 500 nanometers (“nm”), or 100 nm, or 50 nm, or 10 nm, or 5 nm, or 1 nm. In some situations, the particles have diameters between about 1 nm and 1000 um, or 50 nm and 100 um.

The particles may have various shapes and sizes. In some cases, the particles have cross-sections that are circular, oval, triangular, square, rectangular, pentagonal, hexagonal, heptagonal, octagonal, decagonal, or nonagonal. Additionally, the particles have at least one 1, or 2, or 3, or 4, or 5, or 6, or 7, or 8, or 9, or 10, or 11, or 12, or 13, or 14, or 15, or 16, or 17, or 18, or 19, or 20 sides. The particles are two-dimensional or three-dimensional. That is, the particles have thicknesses less than or equal to about 1 monolayer, or greater than 1 monolayer (i.e., multilayer). In some situations, the particles are disposed at or near surface defect locations, such as steps (e.g., monatomic steps), screw dislocations, hairpin turn dislocations and/or edge dislocations.

The carbocatalyst may exhibit various spectroscopic features. In one embodiment, the carbocatalyst exhibits an x-ray diffraction (XRD) spectrum with one or more 20 features between about 0 and 27°. In another embodiment, the carbocatalyst has a decomposition temperature between about −50° C. and 600° C. as measured by TPD. For example, under TPD measurements, CO₂ (mass-to-charge ratio ˜44) and/or H₂O (mass-to-charge ratio ˜18) peaks (as well as cracking patterns) are observed in mass spectrometry signals in the decomposition temperature range.

In one embodiment, the carbocatalyst has a surface electrical conductivity between about 1×10⁻⁶ and 1×10⁴ Siemens (“S”)/m as measured by scanning tunneling microscopy (STM), bulk powder conductivity, or 4-point probe conductivity measurements. In another embodiment, the carbocatalyst has a surface electrical conductivity less than about 10,000 S/m, or 9,000 S/m, or 8,000 S/m, or 7,000 S/m, or 6,000 S/m, or 5,000 S/m, or 4,000 S/m, or 3,000 S/m, or 2,000 S/m, or 1,000 S/m, or 500 S/m, or 100 S/m, or 50 S/m, or 10 S/m, or 5 S/m, or 1 S/m, or 10⁻¹ S/m, or 10⁻² S/m, or 10⁻³ S/m, or 10⁻⁴ S/m, or 10⁻⁵ S/m.

The carbocatalyst may have various surface and bulk spectroscopic characteristics. In one embodiment, the carbocatalyst exhibits a C(1 s) peak at about 286 electron volt (“eV”) and an oxygen (1 s) peak at about 530 eV under XPS measurements. In another embodiment, the carbocatalyst shows one or more Fourier Transform Infrared (“FT-IR”) spectroscopy features at about 3150 cm⁻¹, 1685 cm⁻¹, 1280 cm⁻¹ and 1140 cm⁻¹ (see FIG. 5). In another embodiment, a Raman spectroscopy spectrum of the carbocatalyst shows features at about 1350 cm⁻¹ and/or 1575 cm⁻¹. In some situations, a carbocatalyst formed from graphite will have a Raman spectroscopy spectrum exhibiting a feature at 1350 cm⁻¹. In such a case, the Raman spectrum in some instances will exhibit a feature at 1575 cm⁻¹ but in other instances the 1575 cm⁻¹ features will be absent.

In some embodiments, heterogeneous catalysts include carbon-containing catalysts. Carbon-containing heterogeneous catalysts have features that are similar or identical to the catalysts described above.

In some embodiments, a heterogeneous catalyst comprises a solid support and catalytically-active graphene oxide or catalytically-active graphite oxide particles (or other carbon and oxygen-containing particles) on the solid support. In an embodiment, the graphene oxide or graphite oxide particles are distributed into islands on the solid support, the islands having heights (as measured relative to the solid support) of at least about 2.0 Å, or 3 Å, or 4 Å, or 5 Å, or 6 Å, or 7 Å, or 8 Å, or 9 Å, or 10 Å, or 20 Å, or 30 Å, or 40 Å, or 50 Å, or 100 Å, or 500 Å, or 1000 Å. In another embodiment, the graphene oxide or graphite oxide particles have particle sizes between about 1 nm and 1000 um. In some situations, the graphene oxide or graphite oxide particles have particle sizes less than or equal to about 1000 μm, or 500 μm, or 100 μm, or 50 μm, or 10 μm, or 5 μm, or 1 μm, or 500 nanometers (“nm”), or 100 nm, or 50 nm, or 10 nm, or 5 nm, or 1 nm.

In some situations, the graphene oxide or graphite oxide particles have particle densities between about 0.01 g/cm³ and 10 g/cm³, or 0.1 g/cm³ and 5.0 g/cm³ or 0.2 g/cm³ and 2.2 g/cm³. In an embodiment, each of the particles has an area (A) to circumference (C) ratio between about 1 nanometers (nm) and 10,000 micrometers (pm), or 10 nm and 1,000 μm, or 50 nm and 1 μm. In some situations, A/C is less than or equal to about 10,000 μ, or 5000 μm, or 1000 μm, or 500 μ, or 100 μ, or 50 μ, or 10 μ, or 5 μm, or 1 μm, or 500 nm, or 100 nm, or 50 nm, or 10 nm, or 1 nm, or 0.5 nm, or 0.1 nm, or 0.01 nm, or 0.001 nm. In some cases, each of the particles has an aspect ratio that is less than about 100,000, or 50,000, or 10,000, or 5,000, or 1,000, or 500, or 100, or 50, or 10, or 1. In one example, each of the particles has an aspect ratio that is about 1.

The particles may have various cross-sections. In an embodiment, the particles have cross-sections that are circular, oval, triangular, square, rectangular, pentagonal, hexagonal, heptagonal, octagonal, decagonal, or nonagonal. In some situations, the particles have at least one 1, or 2, or 3, or 4,or 5, or 6, or 7, or 8, or 9, or 10, or 11, or 12, or 13, or 14, or 15, or 16, or 17, or 18, or 19, or 20 sides. The particles are two-dimensional or three-dimensional. In some cases, the particles are disposed at or near surface defect locations, such as steps (e.g., monatomic steps), screw dislocations, hairpin turn dislocations and/or edge dislocations.

In some embodiments, the heterogeneous catalyst has a substantially low metal content. In some situations, the heterogeneous catalyst has a manganese content less than about 1 part per million (“ppm”), or 0.5 ppm, or 0.1 ppm, or 0.06 ppm, or 0.01 ppm, or 0.001 ppm, or 0.0001 ppm, or 0.00001 ppm as measured by atomic absorption spectroscopy or ICP-MS.

In some embodiments, the solid support include a carbon-containing material, such as graphene, graphene oxide, graphite, graphite oxide, or a carbocatalyst. In other embodiments, the solid support includes a non-carbon containing material, such as a metal-containing material. For example, the solid support includes material selected from the group consisting of AlOₓ, TiO_{X}, SiOₓ, ZrOₓ and combinations thereof, wherein ‘x’ is a number greater than zero.

In some cases the particles are distributed into two-dimensional islands on a surface of the solid support at a two-dimensional island density-area covered by the islands divided by the total area of the surface-less than about 100%, or 95%, or 90%, or 85%, or 80%, or 75%, or 70%, or 65%, or 60%, or 55%, or 50%, or 45%, or 40%, or 35%, or 30%, or 25%, or 20%, or 25%, or 20%, or 15%, or 10%, or 5%, or 1%, or 0.1%, or 0.01%, as measured by a surface analytical technique, such as STM or AFM. In some situations, such as at a low surface coverage, the particles are situated predominantly at surface defect locations, such as step locations, screw dislocations, hairpin turn dislocations and/or edge dislocations. Each of the two-dimensional islands has a thickness of a single atom, such as carbon or oxygen if the two-dimensional islands are formed of graphene oxide or graphite oxide. In some cases, the particles are distributed in three-dimensional islands on the solid support. The three dimensional islands are several atoms thick and in some cases have properties that approach or resemble bulk properties of the material that comprises the particles. In one example, the solid support includes three-dimensional particles formed of graphene oxide or graphite oxide, and the three-dimensional particles have properties similar or identical to bulk graphene oxide or graphite oxide. In such a case, each three-dimensional islands includes one or more multilayers of graphene oxide or graphite oxide. In cases in which the particles are distributed into three-dimensional islands, the surface coverage of such islands may be less than 1 ML (island density less than 100%). In other situations, the particles are distributed into two-dimensional and three-dimensional islands.

In some embodiments, a heterogeneous catalyst having graphene oxide or graphite oxide on a solid support has a graphene oxide or graphite oxide content (wt %) of at least about 0.0001%, or 0.001%, or 0.01%, or 0.1%, or 1%, or 5%, or 10%, or 15%, or 20%, or 25%, or 30%, or 35%, or 40%, or 45%, or 50%, or 55%, or 60%, or 65%, or 70%, or 75%, or 80%, or 85%, or 90%, or 95%, or 100%, or 200%, or 300%, or 400%, or 500%, or 1000%, or 5000%, or 10,000%. In some cases, the heterogeneous catalyst has a graphene oxide or graphite oxide surface coverage that is less than or equal to about 1 monolayer (ML), or 0.99 ML, or 0.95 ML, or 0.9 ML, or 0.85 ML, or 0.8 ML, or 0.75 ML, or 0.7 ML, or 0.65 ML, or 0.6 ML, or 0.55 ML, or 0.5 ML, or 0.45 ML, or 0.4 ML, or 0.35 ML, or 0.3 ML, or 0.25 ML, or 0.2 ML, or 0.15 ML, or 0.1 ML, or 0.05 ML, or 0.01 ML, or 0.005 ML, or 0.001 ML, as measured by a surface analytical technique, such as STM or XPS.

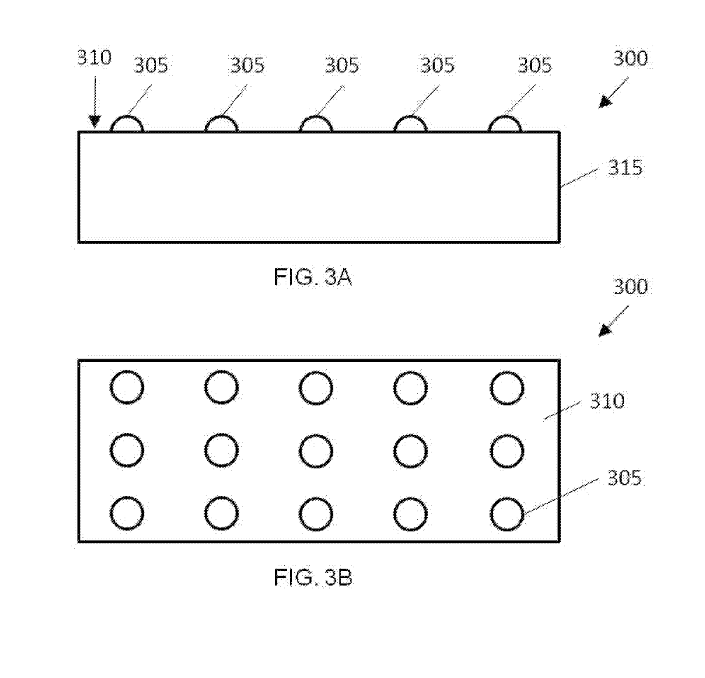

FIG. 3 shows a heterogeneous catalyst 300 having particles 305 disposed on a surface 310 of a solid support 315, in accordance with an embodiment of the invention. The particles 305 are carbon-containing particles, such as, for example, graphene oxide or graphite oxide particles. The particles are catalytically active in oxidation and/or polymerization reactions. In some situations, the solid support 315 is not catalytically active; however, in other situations the solid support is catalytically active in oxidation and/or polymerization reactions. In some embodiments, the particles have surface densities, surface coverage, particles sizes, particle densities and compositions described herein.

In some cases, the heterogeneous catalyst 300, including the particles 305 and the solid support 315, have a substantially low metal (e.g., transition metal) content. In one example, the heterogeneous catalyst 300 has a substantially low concentration of metals selected from the group consisting of W, Fe, Ta, Ni, Au, Ag, Rh, Ru, Pd, Pt, Ir, Co, Mn, Os, Zr, Zn, Mo, Re, Cu, Cr, V, Ti and Nb. In an embodiment, the heterogeneous catalyst 300 has a transition metal concentration that is less than or equal to about 1 part per million (“ppm”), or 0.5 ppm, or 0.1 ppm, or 0.06 ppm, or 0.01 ppm, or 0.001 ppm, or 0.0001 ppm, or 0.00001 ppm as measured by atomic absorption spectroscopy. In another embodiment, the heterogeneous catalyst 300 has a metal content (mole %) that is less than about 0.0001%, or less than about 0.000001%, or less than about 0.0000001%.

In some situations, the particles 305 have a substantially low metal (e.g., transition metal) content. In one example, the particles 305 have a substantially low concentration of metals selected from the group consisting of W, Fe, Ta, Ni, Au, Ag, Rh, Ru, Pd, Pt, Ir, Co, Mn, Os, Zr, Zn, Mo, Re, Cu, Cr, V, Ti and Nb. In an embodiment, the particles 305 have a transition metal concentration that is less than or equal to about 1 part per million (“ppm”), or 0.5 ppm, or 0.1 ppm, or 0.06 ppm, or 0.01 ppm, or 0.001 ppm, or 0.0001 ppm, or 0.00001 ppm as measured by atomic absorption spectroscopy or ICP-MS.

In some cases, the particles 305 have a substantially low manganese content. In one example the particles have a manganese content that is less than about 1 ppm, or 0.5 ppm, or 0.1 ppm, or 0.06 ppm, or 0.01 ppm, or 0.001 ppm, or 0.0001 ppm, or 0.00001 ppm as measured by atomic absorption spectroscopy.

In some embodiments, the particles 305 are localized at defect locations of the solid support 315, such as at step, screw dislocation, hairpin turn dislocations and/or edge dislocations. The distribution of particles may vary based on the material comprising the solid support 315. In some situations, upon use of the catalyst 300, such as in oxidation and polymerization reactions, a spent catalyst formed from the catalyst 300 has spent particles localized at terrace locations (away from steps) or, alternatively, at defect locations. Similar to the catalyst 300, the distribution of particles on the spent catalyst may vary based on the material comprising the solid support 315.

Spent catalysts

In another aspect of the invention, a spent catalyst is described. In some embodiments, the spent catalyst is a spent carbocatalyst, such as a spent graphene oxide or graphite oxide-containing catalyst. The spent catalyst may be formed following oxidation and/or reduction reactions to form a reaction product. In some cases, the spent catalyst has reduced catalytic activity with respect to a fresh catalyst. In some situations, the spent catalyst is a spent heterogeneous catalyst, such as a heterogeneous catalyst employed in an oxidation or polymerization system (see below).

In some embodiments, a spent carbocatalyst includes a carbon-containing material having a Fourier Transform Infrared (FT-IR) spectrum with at least one FT-IR feature at about 3150 cm⁻¹, 1685 cm⁻¹, 1280 cm⁻¹ and 1140 cm⁻¹ that is attenuated with respect to the fresh catalyst. That is, with the fresh carbocatalyst exhibiting FT-IR features at about 3150 cm⁻¹, 1685 cm¹, 1280 cm⁻¹ and/or 1140 cm⁻¹ (see FIG. 5), in an FT-IR spectrum of the spent catalyst one or more of these features are absent or reduced in intensity (collectively referred to as “attenuated” herein). In one example, the spent catalyst exhibits one or more FT-IR features at about 3150 cm⁻¹, 1685 cm⁻¹, 1280 cm⁻¹ and 1140 cm⁻¹ that are reduced in intensity by at least 10%, or 20%, or 30%, or 40%, or 50%, or 60%, or 70%, or 80%, or 90%, or 99% with respect to a fresh catalyst exhibiting one or more such features.

In some embodiments, a spent carbocatalyst comprises a solid support and carbon-containing particles on the solid support. In some cases, each of the particles has a surface area (A) to circumference (C) ratio between about 1 nanometers (nm) and 10,000 micrometers (μm), or 10 nm and 1,000 μm, or 50 nm and 1 μm. In some situations, A/C is less than or equal to about 10,000 μ, or 5000 μ, or 1000 μ, or 500 μ, or 100 μm, or 50 μm or 10 μm, or 5 μm, or 1 μm, or 500 nm, or 100 nm, or 50 nm, or 10 nm, or 1 nm, or 0.5 nm, or 0.1 nm, or 0.01 nm, or 0.001 nm. In some situations, each of the particles has an aspect ratio that is less than about 100,000, or 50,000, or 10,000, or 5,000, or 1,000, or 500, or 100, or 50, or 10, or 1.

In some embodiments, the carbon-containing particles of the spent catalyst has contact angles less than about 180°, or between about 0° and 180°. In an embodiment, the spent carbocatalyst has an XRD spectrum exhibiting one or more two theta (20) features between about 0° and 27°. In another embodiment, the spent carbocatalyst has a surface electrical conductivity between about 1×10⁻⁶ and 1×10³ S/m as measured by STM, bulk powder conductivity, or 4-point probe conductivity measurements. In some situations, the spent carbocatalyst exhibits a C(1 s) peak at about 286 eV and an oxygen (1 s) peak at about 530 eV as measured by XPS.

A spent catalyst may have various bulk properties. For instance, a spent catalyst has a bulk conductivity between about 500 S/m and 6000 S/m, or 1000 S/m and 5500 S/m, or 2000 S/m and 5000 S/m. In some situations, a spent catalyst has a bulk thermal conductivity between about 500 W/m·K and 6000 W/m·K, or 1000 W/m·K and 5500 W/m·K.

Carbocatalyst systems

In another aspect of the invention, carbocatalyst systems are provided. A carbocatalyst system includes a reactor having a carbocatalyst and various unit operations configured to separate reaction products and any byproducts and unused reactants.

In some embodiments, a carbocatalyst system is a graphene oxide or graphite oxide-containing system comprising a source of a carbon-containing reactant and a reactor having a graphene oxide or graphite oxide-containing catalyst downstream from the source of the carbon-containing reactant, the reactor in fluid communication with the source of the carbon-containing reactant. The system includes one or more pumps and valves for directing the flow of fluid to and from the reactor.

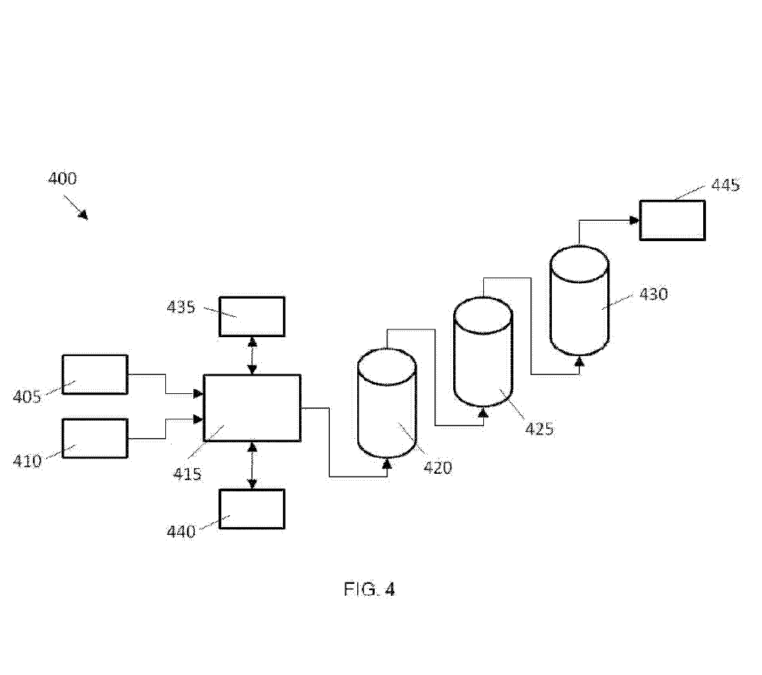

FIG. 4 shows a system 400 having reactant storage units 405 and 410, a reactor 415 downstream from the reactant storage units 405 and 410, and a plurality of separation unit operations downstream from the reactor 415. The plurality of separation unit operations include a first distillation column 420, second distillation column 425 and third distillation column 430. Each of the distillation column includes one or more vapor-liquid equilibrium stages (or “trays”) for effecting a separation of a fluid. Additionally, each of the distillation columns includes a condenser and a reboiler (not shown). The plurality of separations unit operations is configured to separate reaction products (formed in the reactor 415) from other products, byproducts and unused reactants. In some cases, one or more reactants separated by the plurality of separation unit operations is recycled to the reactor 415 to be reacted with the aid of the carbocatalyst in the reactor 415.

While the system 400 includes three distillation columns 420, 425 and 430, the system 400 may include fewer or more distillation columns, as required to effect a product of predetermined composition. In one example, the system 400 includes only one distillation column. As another example, the system 400 includes 2, 4, 5, 6, 7, 8, 9, 10, 11, 12, 13, 14, or 15 distillation columns. The number of distillation columns may be selected based on the number of products generated in the reactor 415. For example, if the reactor generates methanol and ethanol, a single distillation column is generally sufficient to effect the separation of methanol and ethanol into a methanol stream (from the top of the distillation column) and an ethanol stream (from the bottom of the distillation column) However, in cases in which a product stream from the reactor 415 includes unused reactant(s), then additional distillation columns may be required to separate unused reactant from the product(s).

The system 400 includes a heat exchanger 435 in thermal communication with the reactor 415 for providing heat to or removing heat from the reactor. In some situations, the heat exchanger 435 is in fluid communication with other devices, such as a pumps, for circulating a working fluid to and from the heat exchanger 435.

The system 400 includes a catalyst regenerator 440 in fluid communication with the reactor 415 configured to regenerate a carbocatalyst, such as a graphene oxide or graphite oxide-containing catalyst, from a spent catalyst. In some situations, the catalyst regenerator 440 is in fluid communication with a source of a oxidizing chemical (see below) for oxidizing a spent carbocatalyst.

The system 400 includes one or more product storage units (or vessels) for storing one or more reaction products. For example, the system 400 includes a storage unit 445 for storing a product from the third distillation column 430.

The system 400 may include other unit operations. In an example, the system includes one or more unit operations selected from filtration units, solid fluidization units, evaporation units, condensation units, mass transfer units (e.g., gas absorption, distillation, extraction, adsorption, or drying), gas liquefaction units, refrigeration units, and mechanical processing units (e.g., solids transport, crushing, pulverization, screening, or sieving).

The reactor 415 includes a carbocatalyst for facilitating a chemical reaction, such as an oxidation or polymerization reaction. In some embodiments, the carbocatalyst includes graphene, graphene oxide, graphite and/or graphite oxide. In some situations the carbocatalyst includes graphene oxide or graphite oxide.

In some cases, the reactor 415 is operated under vacuum. In an embodiment, the reactor 415 is operated at a pressure less than about 760 torr, or 1 torr, or 1×10⁻³ torr, or 1×10⁻⁴ torr, or 1×10⁻⁵ torr, or 1×10⁻⁶ torr, or 1×10⁻⁷ torr. In other cases, the reactor 415 is operated at elevated pressures, In an embodiment, the reactor 415 is operated at elevated pressures, such as at least 1 atm, or 2 atm, or 3 atm, or 4 atm, or 5 atm, or 6 atm, or 7 atm, or 8 atm, or 9 atm, or 10 atm, or 20 atm, or 50 atm.

In some embodiments, the reactor 415 is a plug flow reactor, continuous stirred tank reactor, semi-batch reactor or catalytic reactor. In some situations, a catalytic reactor is a shell-and-tube reactor or fluidized bed reactor. In other situations, the reactor 415 includes a plurality of reactors in parallel. This may aid in meeting processing needs while keeping the size of each of the reactors within predetermined limits. For example, if 500 liters/hour of ethanol is desired but a reactor is capable of providing 250 liters/hour, then two reactors in parallel will meet the desired output of ethanol.

In some situations, the reactor 415 is a shell-and-tube reactor having graphene oxide or graphite oxide on a solid support. In some situations, the solid support is a carbon-containing support, such as graphene, graphite, graphite oxide or graphene oxide, or a non-carbon containing support, such as an insulating, semiconducting or metallic support. In an example, the support includes one or more materials selected from AlOₓ, TiO_{X}, SiOₓ and ZrOₓ, wherein ‘x’ is a number greater than zero.

In cases in which the reactor 415 is a shell-and-tube reactor, the reactor includes a housing having a reactor inlet and a reactor outlet downstream from the reactor inlet, and one or more tubes in fluid communication with the reactor inlet and the reactor outlet, the one or more tubes having one or more inner surfaces. In some situations, the one or more inner surfaces include graphene oxide, graphite oxide, or other carbocatalyst. In some cases, the one or more inner surfaces of the shell-and-tube reactor include graphene oxide or graphite oxide-containing particles. The one or more tubes are formed of a support material, such as, e.g., a carbon-containing support material (e.g., graphene, graphite, graphene oxide, or graphite oxide) or a non-carbon containing support material (e.g., metallic support material, insulating support material, semiconducting support material). In an example, the support material includes one or more materials selected from the group consisting of AlOₓ, TiO_{X}, SiOₓ, and ZrOₓ, wherein ‘x’ is a number greater than zero.

In some embodiments, the shell-and-tube reactor includes a shell having 1 or more, or 2 or more, or 3 or more, or 4 or more, or 5 or more, or 6 or more, or 7 or more, or 8 or more, or 9 or more, or 10 or more, or 20 or more, or 30 or more, or 40 or more, or 50 or more, or 100 or more, or 200 or more, or 300 or more, or 400 or more or 500 or more, or 1000 or more tubes within the shell. In some situations, the tubes include the catalytically active material, such as a carbocatalyst (e.g., graphene oxide, graphite oxide).

In some situations, the reactor 415 is a fluidized bed reactor. In an embodiment, the fluidized bed reactor includes graphene oxide, graphite oxide, or other carbon and oxygen-containing particles. In some cases, the fluidized bed reactor includes graphene oxide or graphite oxide-containing particles, such as particles having graphene oxide or graphite oxide coated on a solid support. In some cases, the solid support is a carbon-containing support. For instance, the particles include graphene oxide or graphite oxide on a support selected from the group consisting of graphene, graphite, graphite oxide and graphene oxide. In other cases, the particles include graphene oxide or graphite oxide on a non-carbon containing support, such as a metallic support, insulating support or semiconducting support. In an example, the support includes one or more materials selected from the group consisting of AlOₓ, TiO_{X}, SiOₓ and ZrOₓ, wherein ‘x’ is a number greater than zero.

In cases in which the reactor 415 is a fluidized bed reactor, the reactor 415 includes a housing having a reactor inlet and a reactor outlet downstream from the reactor inlet and catalyst particles in the housing. In some situations, the catalyst particles include graphene oxide, graphite oxide, or other carbocatalyst. In some implementations, the reactor 415 includes a mesh at the reactor inlet and a mesh at the reactor outlet for preventing catalyst particles from escaping the reactor 415 during use of the reactor 415.

In some embodiments, the reactor 415 is a fluidized bed reactor and the particles, such as graphene oxide or graphite oxide-containing particles, have diameters between about 1 nanometer (“nm”) and 1000 micrometers (“μm”), or between about 10 nm and 500 μm, or between about 50 nm and 100 μm, or between about 100 nm and 10 μm.

The system 400 includes one or more pumps, valves and control system for regulating the flow of reactants to the reactor 415 and reaction products, byproducts and unused reactants from the reactor 415 and to and from various unit operations of the system 400. In an embodiment, a pump is selected from the group consisting of positive displacement pumps (e.g., reciprocating, rotary), impulse pumps, velocity pumps, gravity pumps, steam pumps, and valveless pumps. In another embodiment, pumps is selected from the group consisting of rotary lobe pumps, progressive cavity pumps, rotary gear pumps, piston pumps, diaphragm pumps, screw pumps, gear pumps, hydraulic pumps, vane pumps, regenerative (peripheral) pumps, peristaltic pumps. In other situations, such as for providing a vacuum to the reactor, the system 400 includes one or more pumps selected from the group consisting of mechanical pumps, turbomolecular (“turbo”) pumps, ion pumps, diffusion pumps and cryogenic (“cryo”) pumps that are in fluid communication with the reactor 415. In some cases, a pump is “backed” by one or more other pumps, such as a mechanical pumps. For example, a turbo pump is backed by a mechanical pump. In some embodiments, valves are selected from the group consisting of ball valves, butterfly valves, ceramic disc valves, check valves (or non-return valves), hastelloy check valves, choke valves, diaphragm valves, stainless steel gate valves, globe valves, knife valves, needle valves, pinch valves, piston valves, plug valves, poppet valves, spool valves, thermal expansion valves.

Methods for forming carbocatalysts and regenerating spent carbocatalysts

In another aspect of the invention, methods for forming carbocatalysts are provided. In embodiments, such methods are used to form catalytically-active graphene oxide, catalytically-active graphite oxide and other catalytically-active carbon and oxygen-containing materials. In an embodiment, such methods are used to regenerate spent catalysts.

In some embodiments, a method for forming a catalytically-active graphene oxide or catalytically-active graphite oxide catalyst from a nascent catalyst comprises providing the nascent catalyst to a reaction chamber (or “reaction vessel”), the nascent catalyst comprising graphene or graphite on a solid support. Next, the nascent catalyst is heated in the reaction chamber to an elevated temperature. The nascent catalyst is then contacted with a chemical oxidant.

In some embodiments, the chemical oxidant includes one or more materials selected from the group consisting of potassium permanganate, hydrogen peroxide, organic peroxides, peroxy acids, ruthenium-containing species (e.g., tetrapropylammonium perruthenate or other perruthenates), lead-containing species (e.g., lead tetraacetate), chromium-containing species (e.g., chromium oxides or chromic acids), iodine-containing species (e.g., periodates), sulfur-containing oxidants (e.g., potassium peroxymonosulfate), molecular oxygen, ozone, chlorine-containing species (e.g., chlorates or perchlorates or hypochlorites), sodium perborate, nitrogen-containing species (e.g., nitrous oxide or dinitrogen tetraoxide), silver containing species (e.g., silver oxide), osmium containing species (e.g., osmium tetraoxide), 2,2′-dipyridyldisulfide, cerium-containing species (e g , ammonium cerium nitrate), benzoquinone, Dess Martin periodinane, meta-chloroperbenzoic acid, molybdenum containing species (e.g., molybdenum oxides), N-oxides (e.g., pyridine N-oxide), vanadium-containing species (e.g., vanadium oxides), (2,2,6,6-tetramethylpiperidin-1-yl)oxidanyl (TEMPO) and iron-containing species (e.g., potassium ferricyanide).

In other embodiments, the chemical oxidant is a plasma excited species of an oxygen-containing chemical. In an example, the chemical oxidant includes plasma-excited species of O₂, H₂O₂, NO, NO₂, or other chemical oxidants. In such a case, the nascent catalyst in the reaction chamber is contacted with plasma excited species of the oxygen-containing chemical continuously, such as for a predetermined period of time of at least about 0.1 seconds, or 1 second, or 10 seconds, or 30 seconds, or 1 minute, or 10 minutes, or 30 minutes, or 1 hour, or 2 hours, or 3 hours, or 4 hours, or 5 hours, or 6 hours, or 12 hours, or 1 day, or 2 days, or 3 days, or 4 days, or 5 days, or 6 days, or 1 week, or 2 weeks, or 3 weeks, or 1 month, or 2 months, or 3 months, or 4 months, or 5 months, or 6 months. Alternatively, the nascent catalyst in the reaction chamber is contacted with plasma excites species of the oxygen-containing chemical in pulses, such as pulses having a duration of at least about 0.1 seconds, or 1 second, or 10 seconds, or 30 seconds, or 1 minute, or 10 minutes, or 30 minutes, or 1 hour, or 2 hours, or 3 hours, or 4 hours, or 5 hours, or 6 hours, or 12 hours, or 1 day, or 2 days, or 3 days, or 4 days, or 5 days, or 6 days, or 1 week, or 2 weeks, or 3 weeks, or 1 month, or 2 months, or 3 months, or 4 months, or 5 months, or 6 months. In some situations, the nascent catalyst is exposed to the chemical oxidant for a time period between about 0.1 seconds and 100 days.

In some situations, the nascent catalyst is heated during exposure to the chemical oxidant. In an example, the nascent catalyst is heated at a temperature between about 10° C. and 3000° C., or 150° C. and 2000° C. In some cases, the nascent catalyst is heated with the aid of a resistive heater in thermal communication with the nascent catalyst, with the aid of convective heating, and/or with the aid of radiative heating.

Alternatively, a method for forming a catalytically-active graphene oxide or catalytically-active graphite oxide catalyst from a nascent catalyst includes providing a nascent catalyst comprising graphene or graphite to a reaction chamber. The reaction chamber has a holder or susceptor for holding one or more nascent catalysts. Next, the nascent catalyst is contacted with one or more acids. In some cases, the one or more acids include sulfuric acid. In some cases, the nascent catalyst is pretreated with potassium persulfate before contacting the nascent catalyst with the one or more acids. Next, the nascent catalyst is contacted with a chemical oxidant. Next, the nascent catalyst is contacted with hydrogen peroxide.

As another alternative, a method for forming a catalytically-active graphene oxide or catalytically-active graphite oxide catalyst from a nascent catalyst includes providing a nascent catalyst comprising graphene or graphite to a reaction chamber. Next, the nascent catalyst is contacted with one or more acids. In some cases, the nascent catalyst is pretreated with potassium persulfate before the nascent catalyst is contacted with the one or more acids. In some cases, the one or more acids include sulfuric acid and nitric acid. The nascent catalyst is then contacted with sodium chlorate, potassium chlorate and/or potassium perchlorate.

In some embodiments, a method for forming a carbocatalyst comprises providing a carbon-containing material in a reaction chamber and contacting the carbon-containing material in the reaction chamber with an oxidizing chemical (also “chemical oxidant” herein) for a predetermined period of time until the carbon-to-oxygen ratio of the carbon-containing material is less than or equal to about 1,000,000 to 1. In some cases, the ratio is determined via elemental analysis, such as XPS. In some embodiments, the time sufficient to achieve such carbon-to-oxygen ratio is at least about 0.1 seconds, or 1 second, or 10 seconds, or 30 seconds, or 1 minute, or 10 minutes, or 30 minutes, or 1 hour, or 2 hours, or 3 hours, or 4 hours, or 5 hours, or 6 hours, or 12 hours, or 1 day, or 2 days, or 3 days, or 4 days, or 5 days, or 6 days, or 1 week, or 2 weeks, or 3 weeks, or 1 month, or 2 months, or 3 months, or 4 months, or 5 months, or 6 months. In some cases, the carbon-containing material is contacted with the chemical oxidant until the carbon-to-oxygen ratio, as determined by elemental analysis, is less than or equal to about 500,000 to 1, or 100,000 to 1, or 50,000 to 1, or 10,000 to 1, or 5,000 to 1, or 1,000 to 1, or 500 to 1, or 100 to 1, or 50 to 1, or 10 to 1, or 5 to 1, or 1 to 1.

As an alternative, a method for forming oxidized and catalytically-active graphite or oxidized and catalytically-active graphene comprises providing graphite or graphene (e.g., graphite or graphene substrate) in a reaction chamber and contacting the graphite or graphene with an oxidizing chemical until an infrared spectroscopy spectrum of the graphite or graphene exhibits one or more FT-IR features at 3150 cm⁻¹, 1685 cm⁻¹, 1280 cm⁻¹ and 1140 cm⁻¹.

In some embodiments, methods for regenerating a spent catalyst, such as a carbocatalyst, include providing the spent catalyst in a reaction chamber or vessel and contacting the spent catalyst with a chemical oxidant. In some cases, the chemical oxidant includes one or more material selected from the group above. In other cases, the chemical oxidant is a plasma excited species of an oxygen-containing chemical. In an example, the chemical oxidant includes plasma-excited species of O₂, H₂O₂, NO, NO₂, or other chemical oxidants. In some embodiments, the spent catalyst is contacted with the chemical oxidant continuously or in pulses, as described above. Contacting the spent catalyst with the chemical oxidant produces a carbocatalyst having a catalytically active material. In an example, contacting a spent catalyst covered with graphene or graphite (or other carbon-containing and oxygen deficient material) forms a layer of catalytically-active graphene oxide or graphite oxide.

### EXAMPLES

### Example 1

### Preparation of Catalytically Active Graphite Oxide

A 100 mL reaction flask is charged with natural flake graphite (2.04 g; SP-1, Bay Carbon Inc. or Alfa Aesar [99%; 7-10 μm]), concentrated sulfuric acid (50 mL), and a stir bar, and then cooled on an ice bath. The flask is then slowly charged with KMnO₄ (6.13 g) over 2 h which affords a dark colored mixture. The mixture is stirred at 0° C. for 1 h. Next, the mixture is stirred for an additional 2 h at room temperature and then at 35° C. for 3 h. The flask is then cooled to room temperature and the resulting viscous dispersion is poured into 1 L of deionized water. A 30% aqueous solution of H₂O2 (5 mL) is then added slowly to the aqueous mixture. The resulting vibrant yellow mixture is then filtered through a coarse flitted funnel or a nylon membrane filter (0.2 μm, Whatman) and the isolated material is washed with additional deionized water (2 L) and 6 N HCl (1 L). The filtered solids are collected and dried under high vacuum to provide a product (4.16 g) as a dark brown powder.

### Example 2

### Preparation of Graphite Oxide

A 100 mL reaction flask is charged with natural flake graphite (6.0 g; SP-1, Bay Carbon Inc. or Alfa Aesar [99%; 7-10 μm]), concentrated sulfuric acid (25 mL), K₂S₂O₈ (5 g), P₂O₅ (5 g), and a stir bar, and then the mixture is heated at 80° C. for 4.5 h. The mixture is then cooled to room temperature. Next, the mixture is diluted with water (1 L) and left undisturbed for a period of about 8-10 hours. The pretreated graphite IS collected by filtration and washed with water (0.5 L). The precipitate is dried in air for 1 day and transferred to concentrated H2SO₄ (230 mL). The mixture is then slowly charged with KMnO₄ (30 g) over 2 h, which affords a dark colored mixture. The rate of addition is carefully controlled to prevent the temperature of the suspension from exceeding 10° C. The mixture is stirred at 0° C. for 1 h. The mixture is then heated at 35° C. for 2 h. The flask is then cooled to room temperature and the reaction is quenched by pouring the mixture into 460 mL of ice water and stirred for 2 h at room temperature. The mixture is further diluted to 1.4 L with water and treated with a 30% aqueous solution of hydrogen peroxide (25 mL). The resulting vibrant yellow mixture is then filtered and washed with an aqueous HCl solution (10%) (2.5 L) and then with water. The filtrate is monitored until the pH value is neutral and no precipitate is observed upon the addition of aqueous barium chloride or silver nitrate to the filtrate. The filtered solids are collected and dried under high vacuum to provide a product (11 g) as a dark brown powder.

### Example 3

### Preparation of Graphite Oxide

A 250 mL reaction flask is charged with natural flake graphite (1.56 g; SP-1 Bay Carbon Inc. or Alfa Aesar [99%; 7-10 μm]), 50 mL of concentrated sulfuric acid, 25 mL fuming nitric acid, and a stir bar, and then cooled in an ice bath. The flask is then charged with NaClO₃ (3.25 g; note: in some cases NaClO₃ is preferable over KClO₃ due to the aqueous insolubility of KClO₄ that may form during the reaction) under stirring. Additional charges of NaClO₃ (3.25 g) are performed every hour for 11 consecutive hours per day. This procedure is repeated for 3 d. The resulting mixture is poured into 2 L deionized water. The heterogeneous dispersion is then filtered through a coarse flitted funnel or a nylon membrane filter (0.2 μm, Whatman) and the isolated material is washed with additional deionized water (3 L) and 6 N HCl (1 L). The filtered solids are collected and dried under high vacuum to provide a product (3.61 g) as a dark brown powder.

### Example 4

### Preparation of graphene oxide

A graphene substrate is provided in a reaction chamber. The substrate does not exhibit FT-IR peaks at 3150 cm⁻¹, 1685 cm⁻¹, 1280 cm⁻¹ and 1140 cm⁻¹. Next, plasma excited species of oxygen are directed from a plasma generator into the reaction chamber and brought in contact with an exposed surface of the graphene substrate. The graphene substrate is exposed to the plasma excited species of oxygen until an FT-IR spectrum of the substrate shows peaks at 3150 cm⁻¹, 1685 cm⁻¹, 1280 cm⁻¹ and 1140 cm⁻¹. The graphene substrate has a layer of graphene oxide on the exposed surface of the graphene substrate.

Systems and methods provided herein may be combined with, or modified by, other systems and methods, such as, for example, systems and/or methods described in U.S. Provisional Patent Application Ser. No. 61/349,378; U.S. Provisional Patent Application Ser. No. 61/440,574; W. S. Hummer Jr. and R. E. Offeman, J. Am. Chem. Soc. 80: 1339 (1958); A. Lerf et al. J. Phys Chem. B 102: 4477-4482 (1998); L. Staudenmaier, Ber. Dtsch. Chem. Ges. 31: 1481-1487 (1898); L. Stuadenmaier, Ber. Dtsch. Chem. Ges. 32:1394-1399 (1899); T. Nakajima et al., Carbon 44: 537-538 (2006); Bégin et at., J. Mol. Catal. A: Chem. 2009, 302, 119-123; Fu et al., Chem. Rev. 1978, 78, 317-361; Dreyer et at., “The Chemistry of Graphene Oxide,” Chem. Soc. Rev. 2010, 39, 228; Szabo et al., “Evolution of Surface Functional Groups in a Series of Progressively Oxidized Graphite Oxides,” Chem. Mater., 2006, 18, 2740; and Marcano et al., “Improved Synthesis of Graphene Oxide,” ACS Nano, 2010, 4, 4806, which are entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A non-transition metal catalyst comprising catalytically-active graphene oxide or catalytically-active graphite oxide, the catalyst having a transition metal content less than about 1 part per million.

2. The catalyst of claim 1, wherein the transition metal content is less than about 100 parts per billion. cm 3-5. (canceled)

6. The catalyst of claim 1, wherein the catalyst has a hydrogen peroxide-terminated surface.

7. The catalyst of claim 1, wherein the catalyst has an OH-terminated surface.

8. A graphene oxide or graphite oxide catalyst having at least about 25% carbon and at least about 0.01% oxygen as measured by x-ray photoelectron spectroscopy (XPS).

9. A graphene oxide or graphite oxide catalyst having graphene oxide or graphite oxide with a carbon-to-oxygen ratio of at least about 0.5:1.

10-13. (canceled)

14. The catalyst of claim 1, wherein the catalyst includes at least one surface moiety selected from the group consisting of an alkyl group, aryl group, alkenyl group, alkynyl group, hydroxyl group, epoxide group, peroxide group, peroxyacid group, aldehyde group, ketone group, ether group, carboxylic acid and carboxylate group.

15-18. (canceled)

19. The catalyst of claim 1, having one or more Fourier Transform Infrared (FT-IR) features at about 3150 cm⁻¹, 1685 cm⁻¹, 1280 cm⁻¹ and 1140 cm⁻¹.

20-66. (canceled)

67. A catalyst system comprising the catalyst of claim 1, and further comprising:
a source of a carbon-containing reactant.

68-72. (canceled)

73. The catalyst system of claim 67, wherein the graphene oxide or graphite oxide-containing particles have diameters between about 1 nanometer (nm) and 1000 micrometers (μm).

74-76. (canceled)

77. The catalyst system of claim 109, further comprising a heat exchanger in thermal communication with the reactor for providing heat to the reactor.

78. (canceled)

79. The catalyst system of claim 109, further comprising one or more unit operations downstream from the reactor for separating reaction products formed in the reactor from any reaction byproducts and unreacted carbon-containing reactant.

80. (canceled)

81. The catalyst system of claim 109, further comprising a catalyst regenerator in fluid communication with the reactor for regenerating the graphene oxide or graphite oxide-containing catalyst.

82-106. (canceled)

107. The catalyst of claim 1, wherein the catalyst includes one or more surface moieties selected from the group consisting of a hydroxyl group, a ketone group, an aldehyde group, and a carboxylic acid group.

108. The catalyst of claim 1, wherein the catalyst is in a reactor downstream from a source of a carbon-containing reactant, the reactor in fluid communication with the source of the carbon-containing reactant.

109. The catalyst system of claim 67, further comprising a reactor having the catalyst downstream from the source of the carbon-containing reactant, the reactor in fluid communication with the source of the carbon-containing reactant.
